(19) United States
(12) Patent Application Publication
(10) Pub. No.: US 2023/0094901 A1
(43) Pub. Date: Mar. 30, 2023

(54) PLANAR ANTENNA AND HIGH-FREQUENCY MODULE INCLUDING SAME

(71) Applicant: YOKOWO CO., LTD., Kita-ku, Tokyo (JP)

(72) Inventor: Kenichi MITSUGI, Gunma (JP)

(73) Assignee: YOKOWO CO., LTD., Kita-ku, Tokyo (JP)

(21) Appl. No.: 17/910,832

(22) PCT Filed: Jan. 21, 2021
(86) PCT No.: PCT/JP2021/002064

§ 371 Date: Sep. 12, 2022

(30) Foreign Application Priority Data
Mar. 26, 2020 (JP) 2020-056686

(51) Int. Cl. H01Q 9/06; H01Q 1/48; H01Q 19/00; H01Q 19/10

(52) U.S. Cl. CPC H01Q 9/065; H01Q 1/48; H01Q 19/005; H01Q 19/10

(57) ABSTRACT

A planar antenna formed on a front surface of a substrate whose back surface serves as a ground surface, the planar antenna includes: a radiating element; a feeding line connected with the radiating element; a first ground element and a second ground element which are respectively electrically connected to the ground surface and are arranged to be opposed to each other across the feeding line; a first parasitic element extending from the first ground element to surround at least a part of the radiating element; and a second parasitic element extending from the second ground element to surround at least a part of the radiating element from an opposite direction from the first parasitic element, wherein the first ground element and the second ground element serve as impedance matching devices for the feeding line.

### TECHNICAL FIELD

The present invention relates to a planar antenna usable in a frequency band of a quasi-millimeter wave band or higher and a high-frequency module including same.

### BACKGROUND ART

A planar antenna used in a high frequency band equivalent to or higher than a microwave band is largely influenced by properness of matching with a feeding line, presence of another high-frequency component arranged near the antenna, and so forth. Further, this kind of planar antenna has been demanded to have a broad band of a usable frequency region.

Regarding to this point, a planar antenna disclosed in Patent Literature 1 includes a central conductor and ground conductors which are arranged on the same plane as the planar antenna. The central conductor is connected with the planar antenna to be electrically connected to that. The ground conductors are formed on both sides of the central conductor at intervals from the central conductor. In each of the ground conductors, around a connection portion with the planar antenna, a tapered region is formed in which the distance between its edge portion and the central conductor almost monotonously increases as the edge portion approaches the planar antenna. By forming the tapered regions, although the antenna is of a planar type, matching between the planar antenna and transmission lines is achieved throughout a frequency region of a comparatively wide band.

A planar antenna disclosed in Patent Literature 2 has a broad band not by adjusting the shapes of ground conductors which are transmission lines as in Patent Literature 1 but by using effects of multi-resonance. That is, a loop conductor having a gap is arranged on a dielectric substrate, and a linear conductor is arranged in an internal portion of the loop conductor. Then, balanced feeding is achieved for a base end portion of the linear conductor and the loop conductor. Accordingly, the loop conductor is caused to serve as a loop radiating element, and the linear conductor is caused to serve as a radiating element of a monopole antenna.

### PRIOR ART DOCUMENTS

### Patent Literature 1

Japanese Patent Laid-Open No. 2006-121643

### Patent Literature 2

Japanese Patent Laid-Open No. 2011-217204

### SUMMARY OF INVENTION

### Problems to be Solved by the Invention

In a planar antenna disclosed in Patent Literature 1, in a case where a central conductor and ground conductors are formed from microstrips, sizes of a substrate and conductors are made smaller as a used frequency becomes higher. Thus, an adjustable change amount of impedance becomes smaller. Further, work for adjusting tapered regions becomes complicated compared to a case where a rectangular region is cut off. Thus, adjustment work for matching is time consuming.

In a configuration of a planar antenna in Patent Literature 2, a back surface of a dielectric substrate cannot be used as a ground surface. Thus, on the back surface side of the dielectric substrate, a metal reflection plate has to be arranged in parallel with that while being spaced apart with an interval of approximately 0.1 of the wavelength of a used frequency.

Further, as a substrate used around a 1 to 10 GHz band, a printed substrate of FR (flame retardant)-4 grade (“FR-4 substrate”) on the basis of glass epoxy is commonly used. In a printed substrate, a transmission speed of a signal becomes a higher speed as permittivity ε of an insulator is lower, and transmission loss becomes larger as a used frequency band becomes higher. Thus, in related art, as a printed substrate used at frequencies equivalent to or higher than a quasi-millimeter wave band, not the FR-4 substrate with high permittivity ε but a high-frequency substrate using a fluororesin with low permittivity and low loss as an insulator has been used. However, the high-frequency substrate is several ten times expensive as the FR-4 substrate. In addition to that, the high-frequency substrate is inferior to the FR-4 substrate in terms of mechanical characteristics (strength and tolerance) and processing. Thus, mass production of a planar antenna usable in a quasi-millimeter wave band or higher has significantly been difficult.

In addition, when a substrate on which a radiating element is mounted is made thick, while the performance of the antenna becomes better in radiating efficiency and durability, mismatching is more likely to occur. For example, it is assumed that characteristic impedance of a feeding line to be connected with an electronic circuit in a subsequent stage is 50Ω. In this case, although a width of a feeding line conforming to permittivity of the substrate has to become large, matching becomes more difficult when the width of the feeding line becomes larger. In addition, when mismatching occurs, the feeding line itself serves as a radiating element, and lowering of a radiant gain and distortion of a beam as expansion of a field intensity are caused due to unnecessary radiation.

One example of an object of the present invention is to provide a planar antenna or a high-frequency module including same that is capable of being used in a quasi-millimeter wave band at a low cost.

### Solution to the Problems

One aspect of the present invention provides a planar antenna formed on a front surface of a substrate whose back surface serves as a ground surface, the planar antenna including: a radiating element; a feeding line which is connected with the radiating element; a first ground element and a second ground element which are respectively electrically connected to the ground surface and are laid in opposite directions across the feeding line; a first parasitic element which extends from the first ground element so as to surround at least a part of the radiating element; and a second parasitic element which extends from the second ground element so as to surround at least a part of the radiating element from an opposite direction from the first parasitic element, in which the first ground element and the second ground element serve as impedance matching devices for the feeding line and as reflectors for the radiating element and the first parasitic element and the second parasitic element serve as adjusters of a signal phase and as wave directors for the radiating element.

Another aspect of the present invention provides a high-frequency module including an antenna unit which is present on a front surface of a printed substrate whose back surface serves as a ground conductor, in which the antenna unit is the planar antenna according to the above aspect and the planar antenna acts in a frequency band equivalent to or higher than a 26 GHz band.

### Advantageous Effects of the Invention

In the above aspects, in a planar antenna or a high-frequency module including same, an influence of presence or the like of another high-frequency component arranged near a radiating element can be inhibited. Further, a structure in which adjustment for impedance matching over a wide bandwidth is easy can be realized at a frequency equivalent to or higher than a quasi-millimeter wave band and at a low cost.

### BRIEF DESCRIPTION OF DRAWINGS

FIG. 1 illustrates six side views illustrating a configuration example of a planar antenna of a first embodiment.

FIG. 2 is an explanatory diagram illustrating sizes and so forth of the planar antenna of the first embodiment.

FIG. 3 is a frequency-VSWR characteristic diagram of the planar antenna of the first embodiment.

FIG. 4 is a diagram illustrating a radiation pattern of the planar antenna of the first embodiment.

FIG. 5 is a diagram illustrating a radiation pattern of a planar antenna of a first comparative example.

FIG. 6 is a diagram illustrating a radiation pattern of a planar antenna of a second comparative example.

FIG. 7A illustrates a radiation pattern in a case where a high-frequency electronic component or the like is not present near a radiating element.

FIG. 7B illustrates a radiation pattern in a case where a high-frequency electronic component or the like is present near the radiating element.

FIG. 8 is a diagram illustrating a part of a configuration of a planar antenna of a second embodiment.

FIG. 9 is a diagram illustrating a part of a configuration of a planar antenna of a third embodiment.

### DESCRIPTION OF EMBODIMENTS

### First Embodiment

A description will hereinafter be made about an example of an embodiment in a case where the present invention is applied to a planar antenna which is capable of being used in a 28 GHz band (26.5 to 29.5 GHz) as a high band of 5G (fifth-generation mobile communication system) and whose tilt angle is about 15 degrees with respect to a perpendicularly upward direction from a ground plane.

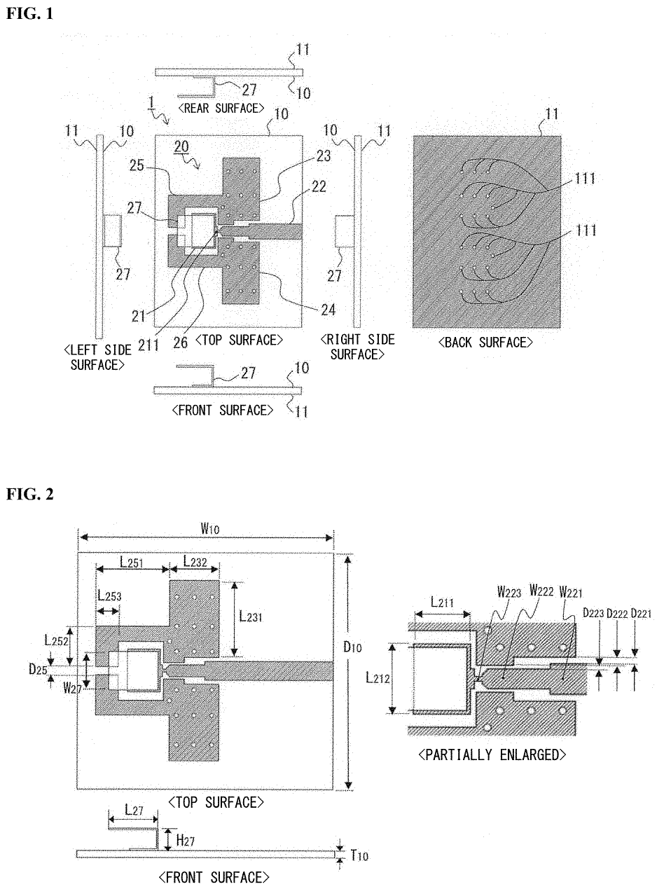

FIG. 1 illustrates six side views illustrating a configuration example of a planar antenna according to a first embodiment. FIG. 2 is a diagram illustrating sizes, arrangement intervals, and so forth of configuration elements.

A planar antenna 1 illustrated in FIG. 1 has an antenna unit 20 laid on a front surface of a printed substrate 10 whose back surface serves as a ground surface 11.

The printed substrate 10 is a glass epoxy substrate which is adequate in view of strength and durability but is not suitable for use for a frequency band of 5G because loss becomes large in the state of the art at the time point of filing the present application, for example, an FR-4 substrate (double-sided substrate).

In the first embodiment, in order to make the printed substrate 10 as small as possible in size, the printed substrate 10 as a general-purpose product is provided whose long side size W₁₀ is 18 mm, short side size D₁₀ is 15 mm, thickness T₁₀ is 0.6 mm, and permittivity ε is 4.0. The ground surface 11 on the back surface of the printed substrate 10 is a copper foil surface with a thickness of 18 μm. The planar antenna 1 which is usable in the 28 GHz band as a high band of 5G can be realized, despite the fact that such a general-purpose and inexpensive FR-4 substrate is used as the printed substrate 10, because of a characteristic structure of the antenna unit 20 which will be described in the following.

The antenna unit 20 has a radiating element 21, a feeding line 22, a first ground element 23, a second ground element 24, a first parasitic element 25, and a second parasitic element 26, which are patterned with conductor films with a thickness of 18 μm. The conductor film is any of copper foil, silver foil, and gold foil, for example, and configures a microstrip. As illustrated in FIG. 1 and FIG. 2, the shapes and disposing positions of those configuration elements 21 to 26 form symmetry with respect to an extended line of a central axis of the feeding line 22. Because the thickness is very small, those configuration elements 21 to 26 are not illustrated in a left side surface, a front surface, and a rear surface in FIG. 1 and in a front surface in FIG. 2.

Further, the antenna unit 20 includes a sheet metal element 27 which is in a rectangle shape when unfolded to a planar state or seen in a top view, and in a general U-shape (general J-shape) in a side view, for example. The sheet metal element 27 may be in a general L-shape in a side view. The shape and structure of the sheet metal element 27 will be described later.

The radiating element 21 may be in an arbitrary shape in which the radiating element 21 serves as a resonant antenna. The radiating element 21 of the first embodiment is in a generally rectangle shape designed to have a size at which the radiating element 21 resonates in the 28 GHz band. A size L₂₁₁ of a short side of this radiating element 21 is about ⅜ (2.35 mm in this example) of the wavelength of a center frequency (28.0 GHz) of the 28 GHz band, and a size L₂₁₂ of a long side is about ½ (2.9 mm in this example) of the above wavelength.

A null point occurs in the radiating element 21. The null point denotes a region where a high-frequency current is canceled by an influence of a reflected wave, an interference wave, or the like in radiation. In antenna engineering, an occurrence of the null point is in general avoided by designing the shape and size of a radiating element so as to make occurrences of null points as few as possible and by devising a measure such as providing a phase difference to a reflected wave in a case where the occurrence is unavoidable. However, in the first embodiment, this null point is actively utilized.

That is, in the first embodiment, a part where the null point occurs in the radiating element 21 is set to a feeding point 211 as a connection part with the feeding line 22. Accordingly, even when the printed substrate 10 becomes thicker, the width of the feeding line 22 thereby becomes larger or the permittivity ε of the printed substrate 10 thereby becomes non-uniform, and mismatching thus occurs more easily, an influence on antenna characteristics (such as VSWRs and directional characteristics) due to the mismatching can be made very small. Further, unnecessary radiation from the feeding line 22 due to that can be prevented. This is one of the reasons why the inexpensive FR-4 substrate can be used in a high frequency band equivalent to or higher than a quasi-millimeter wave band.

As for a shape of the feeding point 211, for removing unnecessary reflection between the radiating element 21 and the feeding line 22 or for fine adjustment for impedance matching, in the example in FIG. 1 and FIG. 2, an example of a rectangle which slightly protrudes in a direction of the feeding line 22 is illustrated. However, an external edge shape of a protruding portion is not limited to the illustrated shape. For example, an arc shape or a trapezoidal shape is possible. Further, not a shape protruding toward the feeding line 22 but a shape recessed to an internal portion of the radiating element 21 may be used, and its most recessed part may be used as the feeding point 211.

The feeding line 22 is shaped such that a line width W₂₂₁ (1.1 mm in this example) of a portion extended from an external circuit, which is not illustrated, then stepwise becomes smaller to a line width W₂₂₂ (0.8 mm in this example) and becomes the smallest line width W₂₂₃ (0.2 mm in this example) around the feeding point 211.

Characteristic impedance of the feeding line 22 is uniquely derived from a known calculation formula of characteristic impedance of a microstrip line, the calculation formula including the line widths W, the permittivity ε of the printed substrate 10, and so forth. In this example, impedances are set to about 210 to 230Ω in a portion of the feeding point 211 (corrected to about 200Ω by adjustment of the external edge shape of the above protruding portion), to the characteristic impedance corresponding to an output of an electronic circuit, which is not illustrated, in a portion of the line width W₂₂₁, to about 50Ω in a portion of the line width W₂₂₂, and to about 100Ω in a portion of the line width W₂₂₃. In other words, in the feeding line 22 in this example, a first characteristic impedance changing point at which the line width W₂₂₁ is stepwise changed to the line width W₂₂₂ and a second characteristic impedance changing point at which the line width W₂₂₂ is changed to the line width W₂₂₃ are formed. However, the positions of the first characteristic impedance changing point and the second characteristic impedance changing point can appropriately be adjusted in accordance with an interval between the first ground element 23 and the second ground element 24 which is necessary for matching.

The number of characteristic impedance changing points is two in the first embodiment but may be three or more. In such a manner, because the feeding line 22 has a shape in which plural characteristic impedance changing points are formed, impedance matching is achieved throughout a wide frequency band.

Here, the line widths of the feeding line 22 are respectively stepwise changed in a manner such that the line width W₂₂₁ is changed to the line width W₂₂₂ and the line width W₂₂₂ is changed to the line width W₂₂₃, mainly, in order to facilitate fine adjustment work for characteristic impedance matching.

That is, work for causing cut amounts of both external edges of the feeding line 22 to accurately agree with each other is much more simplified than a feeding line which is shaped in a tapered manner, for example. Meanwhile, from the line width W₂₂₂ to the line width W₂₂₃, the feeding line 22 is shaped to become smaller in a tapered manner toward the feeding point 211. This is for removing unnecessary reflection by a portion with the line width W₂₂₃, similarly to a case of the feeding point 211. Thus, in a case where unnecessary reflection does not occur, a changing angle from the line width W₂₂₂ to the line width W₂₂₃ may be an acute angle.

In the first embodiment, each of the first ground element 23 and the second ground element 24 is in a planar shape in a generally rectangle shape and is electrically connected to the ground surface 11 on the back surface of the printed substrate 10 through plural conductive through holes 111. Thus, the first ground element 23 and the second ground element 24 provide a ground potential surface with an adequately large area for the antenna unit 20 and can thereby stabilize an action.

A length L₂₃₁ of a long side of the first ground element 23 is desirably set to a frequency on a higher range side in the 28 GHz band. In this example, the length L₂₃₁ is set to about 1 wavelength (5.0 mm in this example) of a frequency of 29.0 GHz. Further, a length L₂₃₂ of a short side is set to about ½ wavelength or about ⅝ wavelength (3.5 mm in this example) of the above frequency. However, a portion close to the second characteristic impedance changing point of the feeding line 22 and a portion close to a feeding part of the radiating element 21 are slightly wider in size than the other portions. Those are procedures for achieving impedance matching in a broader bandwidth.

Among the radiating element 21, the feeding line 22, and the first ground element 23, impedance matching is achieved for reactance produced at an interval among each other. However, because the back surface of the printed substrate 10 is the ground surface 11, strong electric field coupling is made between the radiating element 21 and the ground surface 11. Thus, in order to obtain large reactance between the radiating element 21 and the first ground element 23, matching has to be achieved by narrowing the interval. However, because a reactance change sensitively occurs in the 28 GHz band, fine adjustment of impedance is difficult. Thus, in the first embodiment, a characteristic impedance changing unit for facilitating fine adjustment of reactance is provided.

The characteristic impedance changing unit has, as main elements, an interval between the radiating element 21 and the first ground element 23 (or the second ground element 24) (a first gap produced by this) and an interval between the feeding line 22 and the first ground element 23 (or the second ground element 24) (a second gap produced by this). Reactance of a necessary magnitude is secured by the first gap. Further, the second gap is stepwise changed, and the characteristic impedance is thereby changed. The characteristic impedance changing unit of the first embodiment has a smallest interval D₂₂₃ (0.15 mm) in a portion with the line width W₂₂₂ which is opposed to a portion around the feeding point 211, a largest interval D₂₂₂ (0.5 mm) in a portion with the line width W₂₂₂ which is opposed to the other portions than the above wider portion, and a usual interval D₂₂₁ (0.3 mm) in a portion with the line width W₂₂₂ which is opposed to the above wider portion. Furthermore, the positions of the changing point between the line width W₂₂₃ and the line width W₂₂₂ and the changing point between the line width W₂₂₂ and the line width W₂₂₁ are adjusted in the intervals, the reactance is thereby further changed, fine adjustment of the characteristic impedance is achieved, and matching can thereby be achieved. Accordingly, after performing rough matching at a portion close to the feeding part of the radiating element 21, fine adjustment of impedance matching can be achieved at the characteristic impedance changing points of the feeding line 22, and impedance matching throughout a wide range becomes possible.

The shape, size, and arrangement of the second ground element 24 are the same as the first ground element 23. Although the above description is about the intervals between the first ground element 23 and the radiating element 21 and feeding line 22, a similar description applies to the intervals between the second ground element 23 and the radiating element 21 and feeding line 22. Thus, a description about sizes and so forth by using FIG. 2 will not be made.

In such a manner, each of the first ground element 23 and the second ground element 24 serves as an impedance matching element (one of impedance matching means) for the adjacent radiating element 21. Further, as described above, the first ground element 23 and the second ground element 24, together with the feeding line 22 whose line width is stepwise changed, act also as the characteristic impedance changing unit (another of the impedance matching means) which makes possible impedance matching throughout a wide range. Thus, even if the permittivity ε of the printed substrate 10 is non-uniform, impedance matching can easily be achieved.

In other words, by an action of the first parasitic element 25 and the second parasitic element 26 as resonant elements which will be described later or by cooperation between those and the characteristic impedance matching means which is capable of stepwise fine adjustment of matching for reactance, a usable frequency band can be made a broad band. This is also one of the reasons why even when the general-purpose and inexpensive FR-4 substrate is used as the printed substrate 10 and the width of the feeding line 22 is made large, adequate antenna characteristics can be obtained in a quasi-millimeter wave band.

Further, the long side of each of the first ground element 23 and the second ground element 24 has the length L₂₃₁ at which that serves as a reflector for the radiating element 21 at a used frequency. Thus, the first ground element 23 and the second ground element 24 act to reflect radiation from the radiating element 21 in a direction of the feeding line 22 and can thereby prevent unnecessary radiation from the feeding line 22. Further, the first ground element 23 and the second ground element 24 can reduce distortion of a radiation pattern or lowering of a radiant gain due to another high-frequency component or the like which is present in the direction of the feeding line 22.

The first parasitic element 25 extends from the first ground element 23 so as to surround a part of the radiating element 21. Here, the first parasitic element 25 is arranged to surround the radiating element 21 in a general L-shape. A base end of this first parasitic element 25 is integrated with the first ground element 23 on slightly the feeding line 22 side of a radiating element 21 and in a position slightly spaced apart from an external edge of the radiating element 21. The first parasitic element 25 extends, by almost the length L₂₃₂ of the short side of the first ground element 23, from the base end along an external edge shape of the radiating element 21 and in parallel with the extended line of the central axis of the feeding line 22 in a planar view. Then, in response to a change in the external edge shape of the radiating element 21 at about 90 degrees, the first parasitic element 25 extends in an L-shape while changing its direction, and its distal end becomes an open end. A length L₂₅₃ of the open end is 1.6 mm in this example but is not limited to this.

Further, the second parasitic element 26 extends from the second ground element 24 so as to surround the radiating element 21 from the opposite direction to the first parasitic element 25 and becomes an open end which extends in an L-shape in an upper side view. The open ends of the first parasitic element 25 and the second parasitic element 26 are opposed to each other at a gap D₂₅. An intermediate point of the gap D₂₅ is positioned on the extended line of the central axis of the feeding line 22.

The first parasitic element 25 is electrically connected to the first ground element 23. Further, the second parasitic element 26 is electrically connected to the second ground element 24. In addition, the first ground element 23 and the second ground element 24 are electrically connected to the ground surface on the back surface of the printed substrate 10. Thus, the first parasitic element 25 and the second parasitic element 26 act also as adjusters of a signal phase of the radiating element 21, which will be described later.

Further, the first parasitic element 25 and the second parasitic element 26 act also as resonant elements for multi-resonance. That is, a high-frequency ground current flows through each of the parasitic elements 25 and 26, which are then inductively coupled with the radiating element 21, and the radiating element 21 is excited at a resonance frequency. Each of the parasitic elements 25 and 26 is set to lengths (L₂₅₁ (5 mm in this example)+L₂₅₂ (2.7 mm in this example)) at which that resonates at used frequencies other than the center frequency of the 28 GHz band. Usable frequencies can be made a broad band by this effect of causing multi-resonance between the radiating element 21 and each of the parasitic elements 25 and 26. Further, a gain can be enhanced.

In addition, each of the parasitic elements 25 and 26 is designed such that the length L₂₅₂ of a portion which is parallel with the long sides of the first ground element 23 and the second ground element 24 becomes slightly shorter than ½ wavelength of the 28 GHz band. Accordingly, respective portions in the parasitic elements 25 and 26, the respective portions being generally parallel with the long sides of the first ground element 23 and the second ground element 24, serve as wave directors. Thus, a part of a radiation pattern from the radiating element 21 can be inclined in the opposite direction from the first ground element 23 and the second ground element 24.

Although the shapes of the first ground element 23 and the first parasitic element 25 are different from each other, those are in a positional relationship (including sizes) which forms symmetry of a high-frequency current when seen from the feeding point 211 (null point). That is, at the feeding point 211, electric fields are balanced with each other, and magnetic fields are balanced with each other. Further, the first ground element 23, the first parasitic element 25, and the radiating element 21 are also in a positional relationship (including intervals from the radiating element 21) which forms symmetry of a high-frequency current. Thus, not only the first ground element 23 and the parasitic element 25 but also even including the radiating element 21, at the feeding point 211, electric fields are balanced with each other, and magnetic fields are balanced with each other. Such positional relationships are similarly established between the second ground element 24 and the second parasitic element 26 and between the second ground element 24 and second parasitic element 26 and the radiating element 21.

As described above, with respect to the central axis of the feeding line 22 as the center, the first ground element 23 and the second ground element 24 are arranged to from symmetry, and the first parasitic element 25 and the second parasitic element 26 are arranged to form symmetry. That is, the first ground element 23 and second ground element 24 and the first parasitic element 25 and second parasitic element 26 are in positional relationships which also form structural symmetry. Accordingly, the planar antenna 1 is not unbalanced about a high-frequency current at the feeding point 211, and its action becomes stable. In this case, the null point occurs to radiation around the feeding point 211 as in a dipole antenna.

Next, the sheet metal element 27 will be described in detail. A base end portion with a width (short side) W₂₇ (2.6 mm in this example) of the sheet metal element 27 is soldered onto a surface of the radiating element 21. Further, the sheet metal element 27 protrudes perpendicularly upward from the radiating element 21 by a height H₂₇ (1.8 mm in this example), then changes its direction at an acute angle at a bending point, and extends by a length L₂₇ (3.5 mm) generally in parallel with the radiating element 21, and its distal end becomes a free end.

A line width W₂₇ of the sheet metal element 27 is set equivalent to or a little narrower than a long side of the radiating element 21. This is for causing the free end of the sheet metal element 27 to serve as a wave director for the radiating element 21. The direction is changed at an acute angle at the bending point because such a configuration facilitates design. A portion of the free end overlaps with a part of the open end of the first parasitic element 25 and a part of the open end of the second parasitic element 26 in a top view. This makes a structure in which capacitive reactance is produced by electric field coupling.

The sheet metal element 27 serves as an adjuster of the signal phase of the radiating element 21 and acts also as a wave director and as an adjustment element of directional characteristics and a tilt angle of the radiation pattern.

That is, in order to maintain VSWR characteristics and directional characteristics of the planar antenna 1 to be stable or to make a drop (attenuation) at the null point large, balance of a high-frequency current has to be more certainly achieved. It is possible to adjust balance of a high-frequency current by changing the shapes of the ground elements 23 and 24. However, the radiating element 21 is formed with a microstrip (patch), and when the shape or size of any portion of the radiating element 21 and the ground elements 23 and 24 is changed, the shapes of the other portions have to be changed one after another. Thus, the above adjustment is actually difficult.

The sheet metal element 27 can be used as adjustment means of the signal phase only by changing the length L₂₇ and thereby changing the capacitive reactance produced by electric field coupling between the portion of the free end and the open ends of the parasitic elements 25 and 26. Thus, by using the sheet metal element 27, adjustment of balance of a high-frequency current becomes easy.

Further, by changing the length L₂₇ of the sheet metal element 27, a vector of a high-frequency current and the position of the wave director are changed. Thus, by using the sheet metal element 27, control of the tilt angle of the radiation pattern becomes easy. In experiments by the present inventor, it has become clear that the tilt angle can be changed to around 30 degrees as long as the planar antenna 1 is based on the sizes and arrangement illustrated in FIG. 2.

FIG. 3 illustrates a frequency-VSWR characteristic example of the planar antenna 1 of the first embodiment. FIG. 3 illustrates an output result by a simulator based on the above-described materials, shapes, sizes, and arrangement of the configuration elements. In FIG. 3, it can be understood that in the planar antenna 1, the VSWR becomes 2 or less in the 28 GHz band (26.5 to 29.5 GHz). This can be considered to be mainly because the first ground element 23 and the second ground element 24 effectively serve as the impedance matching means for the feeding line 22 and the first parasitic element 25 and the second parasitic element 26 effectively serve as the resonant elements for the radiating element 21.

In such a manner, it can be understood that while the general-purpose and inexpensive FR-4 substrate is used, and while the antenna has a structure in which impedance matching and its fine adjustment are easy with adequate mechanical strength and at a low cost, the planar antenna 1 of this embodiment can stably secure a gain throughout a broad band of 3 GHz or wider in the 28 GHz band.

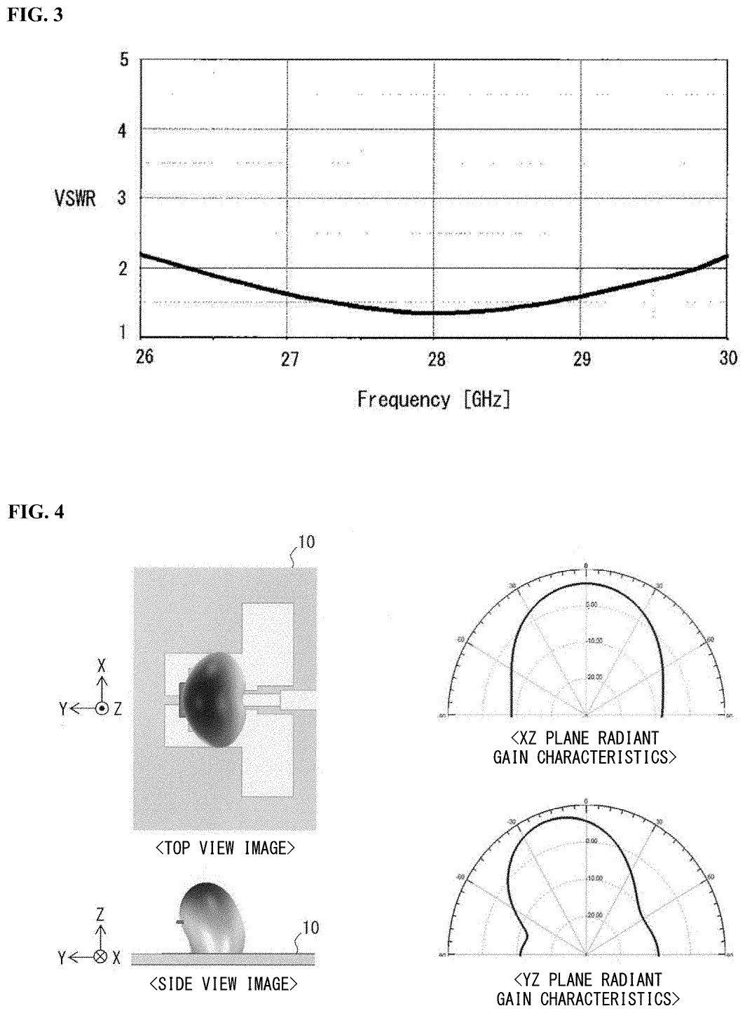

Next, the radiation pattern in the planar antenna 1 will be inspected. FIG. 4 is a diagram illustrating an output result by a simulator based on the above-described materials, shapes, sizes, and arrangement of the configuration elements. For convenience, in FIG. 4, X axis, Y axis, and Z axis as three orthogonal axes will be defined. In those three orthogonal axes, a +Z direction is a perpendicularly upward direction of the feeding point 211, a +X direction is a direction from the feeding point 211 toward the immediately close first parasitic element 25, a −X direction is a direction from the feeding point 211 toward the immediately close second parasitic element 26, a +Y direction is a direction from the feeding point 211 toward the intermediate point of the gap D₂₅, and a −Y direction is a direction from the feeding point 211 toward the feeding line 22.

In the present specification, for convenience, a plane in which the printed substrate 10 is seen in a top view will be referred to as “XY plane”, a plane in which the printed substrate 10 is seen in a side (short side) view will be referred to as “YZ plane”, and a plane in which the feeding point 211 of the printed substrate 10 is seen in a front (long side) view from a direction of the feeding line 22 will be referred to as “XZ plane”.

In FIG. 4, a top view image and a side view image illustrate the radiation pattern from the radiating element 21. The left diagram in FIG. 4 is a diagram which visually expresses the expansion and the magnitude of a field intensity. The diagram indicates that the range in which the field intensity is produced becomes broader as the expansion becomes larger and the field intensity becomes larger as the color becomes darker. Further, the right diagram in FIG. 4 illustrates radiant gain characteristics. In the diagram, as for the radiation pattern in the XZ plane, the +Z direction from the feeding point 211 on the XZ plane is set as 0 degree, this 0 degree is set as the center, and in a range to −90 degrees in the +X direction in which an increment is indicated at each −5 degrees and in a range to +90 degrees in the −X direction in which an increment is indicated at each +5 degrees, the magnitude of a relative radiant gain (dBi) is indicated by concentric circular broken lines at 0.00, −10.00 (dBi), and −20.00 (dBi). As for the radiation pattern in the YZ plane, the +Z direction from the feeding point 211 on the YZ plane is set as 0 degree, this 0 degree is set as the center, and in a range to −90 degrees in the +Y direction in which an increment is indicated at each −5 degrees and in a range to +90 degrees in the −Y direction in which an increment is indicated at each +5 degrees, the magnitude of a relative radiant gain (dBi) is indicated by concentric circular broken lines at 0.00, −10.00 (dBi), and −20.00 (dBi).

Referring to FIG. 4, in the planar antenna 1, the radiation pattern almost uniformly expands in the +X direction and the −X direction on an XZ surface, but the radiant gain relatively largely drops in the vicinity of the feeding line 22. In other words, the radiant gain is rapidly lowered. Further, as indicated by the top view image and the radiation pattern on the XZ plane, compared to the +Z direction, the +Y direction, and the −Y direction, the expansion of the radiation pattern is narrowed in a beam-like manner, and the radiant gain becomes high. In addition, as indicated by the side view image and the radiation pattern on the YZ plane, the portion in which the radiant gain becomes high is inclined in the +Y direction on the YZ plane. In other words, the radiation pattern is tilted in the +Y direction. It can be understood that because the radiation pattern is not inclined in the −Y direction, unnecessary radiation from the feeding line 22 and an influence on a subsequent stage side are extremely close to zero.

The radiation pattern is not inclined in the −Y direction because the first ground element 23 and the second ground element 24 serve as the reflectors for the radiating element 21 and a side surface portion of the first parasitic element 25 in the +Y direction, a side surface portion of the second parasitic element 26 in the +Y direction, and an open end of the sheet metal element 27 serve as wave directors for the radiating element 21.

The tilt angle is capable (easily) of being adjusted by changing the length L₂₇ and the height H₂₇ of the sheet metal element 27 and the magnitude of capacitive coupling between the open ends of the first parasitic element 25 and the second parasitic element 26. Alternatively, adjustment is possible (easy) also by changing the sizes of the ground elements 23 and 24 and the direction of the vector of a high-frequency current.

The radiation pattern almost uniformly expands in the +X direction and the −X direction with the radiating element 21 being the center and is inclined while the beam is narrowed because the first ground element 23, the second ground element 24, the first parasitic element 25, the second parasitic element 26, and the sheet metal element 27 around the radiating element 21 are arranged in the shapes and sizes illustrated in FIG. 2.

Further, the radiant gain becomes relatively small in the vicinity of the feeding line 22 because the feeding point 211 is set as the null point of the radiating element 21. The radiation pattern on the XY plane is capable of being adjusted by changing gaps or the like between the radiating element 21 and the first parasitic element 25 and second parasitic element 26.

As described above, the fact that an influence on the radiation pattern by the printed substrate 10 is small is one of the reasons why the general-purpose and inexpensive FR-4 substrate can be used for the printed substrate 10.

### Comparative Examples

In order to more specifically inspect functions and effects of the configuration elements in the planar antenna 1, the present inventor separately created a planar antenna of a first comparative example in which a part of the configuration elements were omitted and conducted a simulation of an action about this planar antenna under a condition in which materials, sizes, and arrangement were made the same as the planar antenna 1.

FIG. 5 is a diagram illustrating a radiation pattern of the planar antenna of the first comparative example. The point that a top view image and a side view image are diagrams which visually express the expansion and the magnitude of a field intensity about a radiation pattern from a radiating element and the way of viewing the radiation pattern on the YZ plane are the same as FIG. 4. This planar antenna of the first comparative example is a planar antenna in a configuration in which no sheet metal element 27 is provided.

FIG. 5 does not illustrate the radiation pattern on the XZ plane which is illustrated in FIG. 4. This is because the radiation pattern on the XZ plane does not exhibit a significant difference in the configuration in which no sheet metal element 27 is provided. A reason why no significant difference is exhibited can be considered to be because the feeding point 211 is set as the null point of the radiating element 21 and functions of using the feeding line 22, the first ground element 23, and the second ground element 24 as the impedance matching means are obtained.

A significant difference from the planar antenna 1 is exhibited in the radiation pattern on the YZ plane. That is, in the planar antenna of the first comparative example, compared to the planar antenna 1, narrowing of the beam in the +Y direction is gentle, and the drop at the null point is small. Further, the expansion of the radiation pattern around the feeding point is broader than the planar antenna 1, and further, as illustrated in the side view image, the expansion of the radiation pattern in the −Y direction slightly leans toward the feeding line 22. This is because in the planar antenna of the first comparative example, fine adjustment of a phase and a wave director action by the sheet metal element 27 are not present. To put it the other way around, this fact means that the sheet metal element 27 of the planar antenna 1 plays a major role in functions of phase adjustment and the wave director.

Even in the planar antenna in the first comparative example, a direction in which the radiant gain becomes largest is still inclined in the +Y direction. This is because the first ground element 23 and the second ground element 24 serve as the reflectors for the radiating element 21 and thereby inhibit radiation in a direction of the first ground element 23 and in a direction of the second ground element 24. Further, that is also because the side surface portion of the first parasitic element 25 in the +Y direction and the side surface portion of the second parasitic element 26 in the +Y direction serve as the wave directors for the radiating element 21.

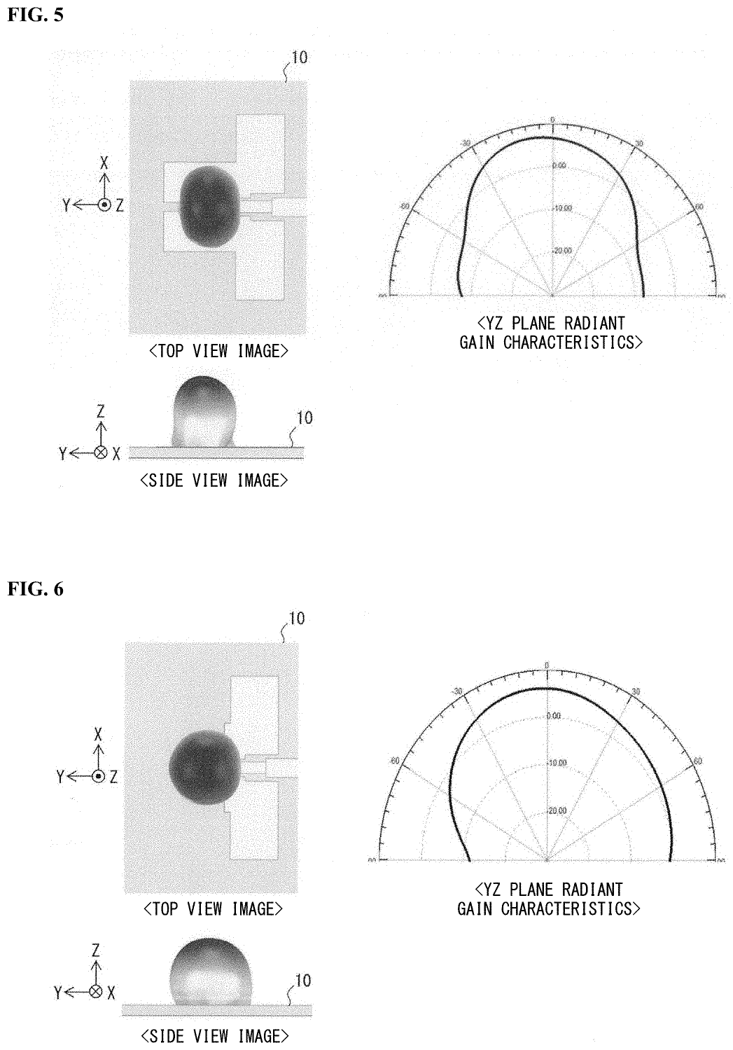

Next, a planar antenna of a second comparative example will be described. The planar antenna of the second comparative example is a planar antenna in a configuration in which none of the sheet metal element 27, the first parasitic element 25, and the second parasitic element 26 are provided. FIG. 6 is a diagram illustrating a radiation pattern of the planar antenna of the second comparative example. The point that a top view image and a side view image are diagrams which visually express the expansion and the magnitude of a field intensity about a radiation pattern from a radiating element and the way of viewing the radiation pattern on the YZ plane are the same as FIG. 4.

FIG. 6 does not illustrate the radiant gain characteristics on the XZ plane which are illustrated in FIG. 4. This is because the radiation pattern on the XZ plane does not exhibit a significant difference. A reason for this fact is also because the feeding point 211 is set as the null point of the radiating element 21 and functions of using the feeding line 22, the first ground element 23, and the second ground element 24 as the impedance matching means are obtained.

A significant difference is exhibited in the radiation pattern on the YZ plane, similarly to the example illustrated in FIG. 5. That is, as illustrated in the top view image in FIG. 6, in the planar antenna of the second comparative example, narrowing of the beam is not present, the radiant gain is lowered, and the expansion of the radiation pattern is broad in all of the +X direction, the −X direction, the +Y direction, and the −Y direction. Further, the expansion of the radiation pattern expands considerably in the direction of the feeding line 22 compared to the example in FIG. 5. This is because balance of a high-frequency current in ground is largely degraded, the drop at the null point becomes small, and radiation in the −Y direction becomes stronger. Further, narrowing is not present on the YZ plane because the wave director action of the first parasitic element 25 and the second parasitic element 26 is not present. To put it the other way around, this fact means that in the first parasitic element 25 and the second parasitic element 26 of the planar antenna 1, particularly side surfaces of those in the +Y direction which function as the wave directors play a major role.

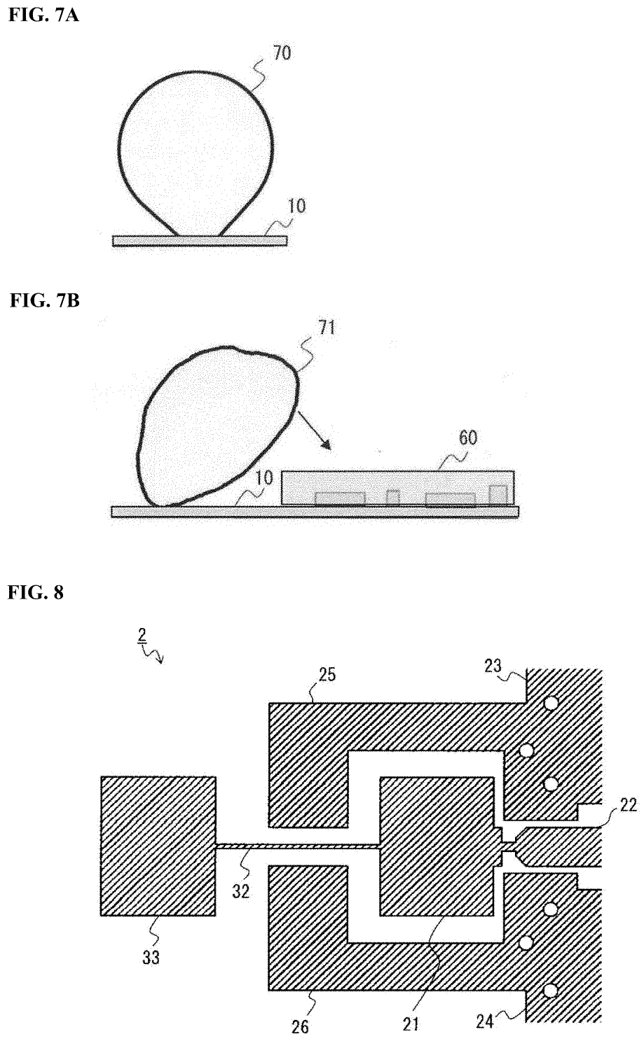

In a case of a common planar antenna having directivity in the +Z direction, in an environment where no other high-frequency component than a radiating element is present on a printed substrate 10 patterned with the radiating element, a radiation pattern 70 illustrated in FIG. 7A is exhibited. When another high-frequency component 60 is arranged on the printed substrate 10, as illustrated in FIG. 7B, a radiation pattern 71 is exhibited which is drawn toward the high-frequency component 60. In a case where the high-frequency component 60 is covered by a shield member, such a tendency becomes significant. This point is similar in a case where another high-frequency component is present near the planar antenna 1 of the first embodiment.

In this case, the size and so forth of the sheet metal element 27 are in advance changed, and the tilt angle of the radiation pattern is thereby inclined in the opposite direction to the direction in which the high-frequency component is present. Accordingly, even when the radiation pattern is drawn toward the high-frequency component, its influence can be alleviated.

As described above, in the first embodiment, because the FR-4 substrate used as the printed substrate 10 has large loss in the 28 GHz band, its size is made as small as possible, and the radiant gain is enhanced to a practical level by a measure against unnecessary radiation, a measure for directivity, and a measure for phase adjustment.

In the measure against unnecessary radiation, a conductive pattern is formed as a symmetrical structure with respect to the feeding point 211, and the portion around the feeding point 211 thereby becomes the null point. However, in such a case, the radiation pattern might be drawn (the radiation pattern might be split) in the +X direction and the −X direction, and further a part of the radiation pattern might be leaked in the −Y direction.

Accordingly, in the planar antenna 1 of the first embodiment, the first ground element 23 and the second ground element 24 are caused to act also as the reflectors for the radiating element 21, unnecessary radiation (radiation loss) of the feeding line 22 is thereby removed, and the radiation pattern is prevented from being split.

In the measure for directivity, wave director functions are used. That is, in the planar antenna 1 of the first embodiment, a part of the first parasitic element 25, a part of the second parasitic element 26, and the free end of the sheet metal element 27 are caused to act also as the wave directors for the radiating element 21, the radiation pattern from the radiating element 21 is thereby narrowed in a beam-like manner, and further the narrowed radiation pattern is caused to be inclined in the +Y direction.

The measure for phase adjustment is a measure for solving adjustment problems which might occur by positioning the first ground element 23, the second ground element 24, the first parasitic element 25, the second parasitic element 26, and the sheet metal element 27 adjacently to each other around the radiating element 21. In a common idea about a high frequency band, conductive elements which induce a high-frequency current (including a vector component) are not adjacently positioned. However, in the planar antenna 1 of the first embodiment, because adjustment of the signal phase is possible by reactance produced by the electric field coupling produced between a distal end portion of the sheet metal element 27 and the open end of the first parasitic element 25 and the open end of the second parasitic element 26 and further two parasitic elements are present, it is possible to reduce an influence on one parasitic element.

In such a manner, the planar antenna 1 of the first embodiment serves as a composite antenna which is based on a magnetic current (magnetic field) antenna and to which a design concept of an electric field antenna is added.

### Second Embodiment

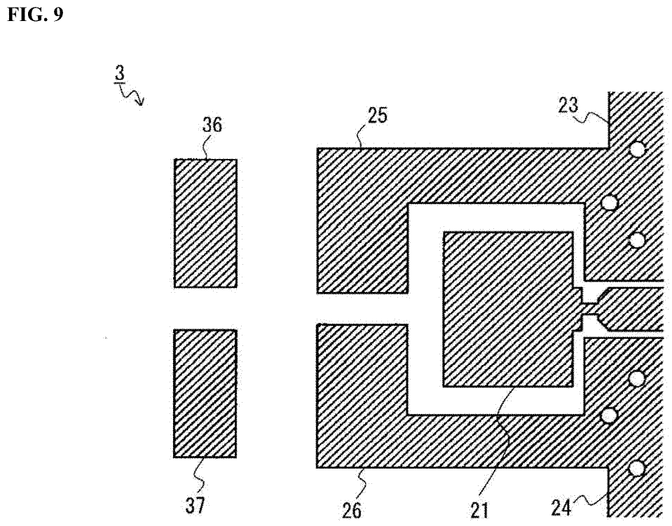

FIG. 8 is a diagram illustrating a part of a configuration of a planar antenna 2 according to a second embodiment of the present invention and illustrates only different portions from the first embodiment. The same reference characters are given to the same configuration elements described in the first embodiment, and descriptions thereof will not be made.

In this planar antenna 2, a transmission line 32 passes through a portion between the open end of the first parasitic element 25 and the open end of the second parasitic element 26. This transmission line 32 extends from the radiating element 21 as a base end, and its terminal end is connected with a second radiating element 33 to be electrically connected to that. The second radiating element 33 has the same shape and size as the radiating element 21. Further, the second radiating element 33 forms an array structure with the radiating element 21. The transmission line 32 has about ½ length of the wavelength of the used frequency. The width of the transmission line 32 is the same as or thinner than the line width W₂₂₃ of the feeding line 22 connected with the feeding point 211.

This planar antenna 2 can more enhance a gain than the planar antenna 1 by phase synthesis between the radiating element 21 and the second radiating element 33. Further, the planar antenna 2 can further narrow the radiation pattern in the +Y direction. Although FIG. 8 does not illustrate the sheet metal element 27, similarly to the planar antenna 1, a configuration is possible in which the sheet metal element 27 is present. Further, the second radiating element 33 is not limited to the same shape and size as the radiating element 21. The second radiating element 33 may have a shape and a size in which similar radiation to the radiating element 21 can be achieved and adjustment of the signal phase and impedance matching are achieved.

### Third Embodiment

FIG. 9 is a diagram illustrating a part of a configuration of a planar antenna 3 according to a third embodiment of the present invention and illustrates only different portions from the first embodiment. The same reference characters are given to the same configuration elements described in the first embodiment, and descriptions thereof will not be made.

In this planar antenna 3, on the opposite side from the radiating element 21 with respect to the open end of the first parasitic element 25 and the open end of the second parasitic element 26 which serve as a center, plural auxiliary parasitic elements 36 and 37 are present. The plural auxiliary parasitic elements 36 and 37 have slightly shorter sizes than the lengths of the side surface portion of the first parasitic element 25 and the side surface portion of the second parasitic element 26 in the +Y direction. The plural auxiliary parasitic elements 36 and 37 are arranged in the same plane as the radiating element 21 and the side surface portions of the first parasitic element 25 and the second parasitic element 26 in the +Y direction.

Further, the auxiliary parasitic element 36 is arranged in a position, in which that serves as a wave director for the radiating element 21, in the +Y direction from the side surface portion of the first parasitic element 25 in the +Y direction. The auxiliary parasitic element 37 is arranged in a position, in which that serves as a wave director for the radiating element 21, in the +Y direction from the side surface portion of the second parasitic element 26 in the +Y direction. The above positions are at about ¼ or about ⅛ of a wavelength λ of the used frequency.

In this planar antenna 3, electric field intensities in the +Y direction make each other stronger, and the tilt angle can be made larger. Although FIG. 9 does not illustrate the sheet metal element 27, similarly to the planar antenna 1, a configuration is possible in which the sheet metal element 27 is present. Further, although FIG. 9 illustrates two auxiliary parasitic elements 36 and 37, the number of auxiliary parasitic elements may be only one or three or more as long as the condition that those serve as wave directors is satisfied. Further, the shapes of the auxiliary parasitic elements 36 and 37 may be rectangles or trapezoids as long as the condition that those serve as wave directors is satisfied.

### Other Embodiments

In the first to third embodiments, descriptions are made about examples of cases where configurations of the present invention are applied to the planar antennas 1, 2, and 3 which are usable in the 28 GHz band (26.5 to 29.5 GHz). However, the sizes and intervals of the configuration elements are changed, and the planar antennas can thereby be practiced as planar antennas to be used in a 26 GHz band (24.25 to 27.5 GHz) or other frequency bands.

Further, in the first to third embodiments, descriptions are made about examples of cases where the FR-4 substrate is used as the printed substrate 10; however, substrates of grades of FR-1, FR-2, FR-3, and FR-5 can be used. Further, it is possible to use a ceramic substrate (alumina), a multilayer substrate, and so forth.

Further, the planar antennas 1, 2, and 3 of the first to third embodiments can be practiced as one high-frequency module, which is usable in a quasi-millimeter wave band, together with an RF detector or another high-frequency component, for example.

[Field of Use]

The planar antennas 1, 2, and 3 of the first to third embodiments are expected to be applied as antenna devices in various fields such as monitoring and watching (security and nursing), IoT (such as content distribution), AI (such as autonomous driving), medicine, and health care.

The present specification provides the following aspects.

<First Aspect>

A first aspect provides a planar antenna formed on a front surface of a substrate whose back surface serves as a ground surface, the planar antenna including:

a radiating element; a feeding line which is connected with the radiating element; a first ground element and a second ground element which are respectively electrically connected to the ground surface and are arranged to be opposed to each other across the feeding line; a first parasitic element which extends from the first ground element so as to surround at least a part of the radiating element; and a second parasitic element which extends from the second ground element so as to surround at least a part of the radiating element from an opposite direction from the first parasitic element, in which the first ground element and the second ground element serve as impedance matching devices for the feeding line and the first parasitic element and the second parasitic element serve as adjusters of a signal phase of the radiating element.

In the first aspect, the first ground element and the second ground element serve as impedance matching elements for the adjacent radiating element and act also as characteristic impedance changing units which are capable of impedance matching throughout a broad band. Thus, even when permittivity of the substrate is non-uniform, impedance matching can easily be achieved. Further, the first parasitic element and the second parasitic element serve as resonant elements, thus are inductively coupled with the radiating element, and cause multi-resonance. Usable frequencies can be made a broad band by an effect of this multi-resonance. Further, a gain can be enhanced. Accordingly, even when the general-purpose and inexpensive FR-4 substrate is used as the substrate and the width of the feeding line is made large, a planar antenna can be realized which can obtain sufficient antenna characteristics in a quasi-millimeter wave band even at a low cost.

<Second Aspect>

A second aspect provides the planar antenna according to the first aspect, in which the first ground element and the second ground element act also as reflectors for the radiating element.

In the second aspect, unnecessary radiation from the feeding line can be prevented. Further, distortion of a radiation pattern or lowering of a radiant gain due to another high-frequency component or the like which is present in a direction of the feeding line can be reduced.

<Third Aspect>

A third aspect provides the planar antenna according to the first aspect or the second aspect, in which the first parasitic element and the second parasitic element act also as wave directors for the radiating element.

In the third aspect, a radiation pattern from the radiating element can be inclined, and control of a tilt angle of the radiation pattern becomes possible.

<Fourth Aspect>

A fourth aspect provides the planar antenna according to any of the first aspect to the third aspect, in which the feeding line is a planar line and a width of the feeding line is smallest at a connection part with the radiating element.

In the fourth aspect, fine adjustment of impedance matching becomes possible. Further, unnecessary reflection between the radiating element and the feeding line can be removed.

<Fifth Aspect>

A fifth aspect provides the planar antenna according to the fourth aspect, in which characteristic impedance of the feeding line is largest at a connection part with the radiating element.

In the fifth aspect, fine adjustment work for characteristic impedance matching becomes easy.

<Sixth Aspect>

A sixth aspect provides the planar antenna according to the fourth aspect or the fifth aspect, in which the connection part is a null point of the radiating element.

In the sixth aspect, even when difficulty in matching occurs because the width of the feeding line becomes larger due to thickening of the substrate or the permittivity of the substrate becomes non-uniform, an influence on antenna characteristics (such as VSWRs and directivity characteristics) due to that can be made very small. Further, unnecessary radiation from the feeding line can be prevented. Accordingly, the inexpensive FR-4 substrate can be used in a high frequency band equivalent to or higher than a quasi-millimeter wave band.

<Seventh Aspect>

A seventh aspect provides the planar antenna according to any of the first aspect to the sixth aspect, in which the radiating element resonates at a first frequency, and the radiating element causes multi-resonance at a second frequency, which is different from the first frequency, between the radiating element and the first parasitic element and the second parasitic element.

In the seventh aspect, by an effect of multi-resonance, usable frequencies can be made a broad band, and further the gain can be enhanced. Accordingly, even when the general-purpose and inexpensive FR-4 substrate is used as the substrate and the width of the feeding line is made large, a planar antenna can be obtained which can obtain sufficient antenna characteristics in a quasi-millimeter wave band at a low cost.

<Eighth Aspect>

An eighth aspect provides the planar antenna according to any of the first to seventh aspects, in which respective shapes and disposing positions of the radiating element and the feeding line form symmetry with respect to a central axis of the feeding line and disposing positions of the first ground element and the first parasitic element and disposing positions of the second ground element and the second parasitic element form symmetry with respect to the central axis of the feeding line.

In the eighth aspect, a high-frequency current at a feeding point does not become unbalanced, and an action can be stabilized.

<Ninth Aspect>

A ninth aspect provides the planar antenna according to any of the first aspect to the eighth aspect, in which the first parasitic element and the second parasitic element have respective open ends which are opposed to each other at a predetermined distance and parts of the open ends, the parts being generally parallel with the radiating element, are positioned so as to serve as the wave directors for the radiating element.

In the ninth aspect, the radiation pattern from the radiating element can be inclined. Thus, control of the tilt angle of the radiation pattern becomes easy.

<Tenth Aspect>

A tenth aspect provides the planar antenna according to the ninth aspect, in which a transmission line which extends from the radiating element as a base end passes through a portion between the open end of the first parasitic element and the open end of the second parasitic element and a terminal end of the transmission line is connected with a second radiating element to be electrically connected to the second radiating element.

In the tenth aspect, a first radiating element and the second radiating element form an array antenna structure. Thus, the radiant gain can be enhanced. Further, the radiation pattern in the Y direction can be narrowed.

<Eleventh Aspect>

An eleventh aspect provides the planar antenna according to the tenth aspect, in which on an opposite side from the radiating element with respect to the open end of the first parasitic element and the open end of the second parasitic element which serve as a center, at least one auxiliary parasitic element which serves as a wave director for the radiating element is positioned.

In the eleventh aspect, the radiation pattern from the radiating element can be inclined. Thus, control of the tilt angle of the radiation pattern becomes easy.

<Twelfth Aspect>

A twelfth aspect provides the planar antenna according to any of the ninth aspect to the eleventh aspect, in which a sheet metal element is connected with a surface of the radiating element to be electrically connected to the surface of the radiating element, the sheet metal element being capacitively coupled with the open end of the first parasitic element and the open end of the second parasitic element at an end portion of the sheet metal element.

In the twelfth aspect, the sheet metal element is capacitively coupled with the open end of the first parasitic element and the open end of the second parasitic element. Thus, the sheet metal element serves as an adjuster of the signal phase of the radiating element. By this action of the sheet metal element, the signal phase can be adjusted only by changing capacitive reactance of the capacitive coupling. Thus, adjustment of balance of a high-frequency current becomes easy.

<Thirteenth Aspect>

A thirteenth aspect provides the planar antenna according to the twelfth aspect, in which the sheet metal element serves as a wave director for the radiating element.

In the thirteenth aspect, the radiation pattern from the radiating element can be inclined. Thus, control of the tilt angle of the radiation pattern becomes easy.

<Fourteenth Aspect>

A fourteenth aspect provides a high-frequency module including an antenna unit which is present on a front surface of a substrate whose back surface serves as a ground conductor, in which the antenna unit is the planar antenna according to any of the first aspect to the thirteenth aspect and the planar antenna has a size in which the planar antenna acts in a frequency band equivalent to or higher than a 26 GHz band.

In the fourteenth aspect, a high-frequency module can be obtained which is capable of being used in a quasi-millimeter wave band at a low cost.

1. A planar antenna formed on a front surface of a substrate whose back surface serves as a ground surface, the planar antenna comprising:
a radiating element;
a feeding line connected with the radiating element;
a first ground element and a second ground element which are respectively electrically connected to the ground surface and are arranged to be opposed to each other across the feeding line;
a first parasitic element extending from the first ground element to surround at least a part of the radiating element; and
a second parasitic element extending from the second ground element to surround at least a part of the radiating element from an opposite direction from the first parasitic element,
wherein the first ground element and the second ground element serve as impedance matching devices for the feeding line and the first parasitic element and the second parasitic element serve as adjusters of a signal phase of the radiating element.

2. The planar antenna according to claim 1, wherein the first ground element and the second ground element also act as reflectors for the radiating element.

3. The planar antenna according to claim 1, wherein the first parasitic element and the second parasitic element act also as wave directors for the radiating element.

4. The planar antenna according to claim 1, wherein the feeding line is a planar line and a width of the feeding line is smallest at a connection part with the radiating element.

5. The planar antenna according to claim 1, wherein characteristic impedance of the feeding line is largest at a connection part with the radiating element.

6. The planar antenna according to claim 4, wherein
the connection part is a null point of the radiating element.

7. The planar antenna according to claim 1, wherein the radiating element resonates at a first frequency, and the radiating element causes multi-resonance at a second frequency, which is different from the first frequency, between the radiating element and the first parasitic element and the second parasitic element.

8. The planar antenna according to claim 1,
wherein respective shapes and disposing positions of the radiating element and the feeding line form symmetry with respect to a central axis of the feeding line, and
wherein disposing positions of the first ground element and the first parasitic element and disposing positions of the second ground element and the second parasitic element form symmetry with respect to the central axis of the feeding line.

9. The planar antenna according to claim 1,
wherein the first parasitic element and the second parasitic element have respective open ends which are opposed to each other at a predetermined distance, and
wherein parts of the open ends, the parts being generally parallel with the radiating element, are positioned so as to serve as the wave directors for the radiating element.

10. The planar antenna according to claim 9, wherein a transmission line which extends from the radiating element as a base end passes through a portion between the open end of the first parasitic element and the open end of the second parasitic element and a terminal end of the transmission line is connected with a second radiating element to be electrically connected to the second radiating element.

11. The planar antenna according to claim 10, wherein on an opposite side from the radiating element with respect to the open end of the first parasitic element and the open end of the second parasitic element which serve as a center, at least one auxiliary parasitic element which serves as a wave director for the radiating element is positioned.

12. The planar antenna according to claim 9, wherein a sheet metal element having an end portion is connected with a surface of the radiating element to be electrically connected to the radiating element, the sheet metal element being capacitively coupled with the open end of the first parasitic element and the open end of the second parasitic element at the end portion.

13. The planar antenna according to claim 12, wherein the sheet metal element serves as a wave director for the radiating element.

14. A high-frequency module comprising
an antenna unit which is present on a front surface of a substrate whose back surface serves as a ground conductor,
wherein the antenna unit is the planar antenna according to claim 1, and
wherein the planar antenna has a size in which the planar antenna acts in a frequency band equivalent to or higher than a 26 GHz band.
